(19) United States
(12) Patent Application Publication
(10) Pub. No.: US 2024/0084698 A1
(43) Pub. Date: Mar. 14, 2024

(54) METHODS AND DEVICES FOR DYNAMIC PORE NETWORK MODELING OF TWO-PHASE FLOW IN WATER-WET POROUS MEDIA

(71) Applicant: UNIVERSITY OF WYOMING, Laramie, WY (US)

(72) Inventors: Yanbin GONG, Laramie, WY (US); Mohammad SEDGHI, Laramie, WY (US); Mohammad PIRI, Laramie, WY (US)

(21) Appl. No.: 18/239,543

(22) Filed: Aug. 29, 2023

Related U.S. Application Data
(60) Provisional application No. 63/402,001, filed on Aug. 29, 2022.

(51) Int. Cl. E21B 49/08

(52) U.S. Cl. CPC E21B 49/087; E21B 2200/20; E21B 2200/22

(57) ABSTRACT

A method and system for predicting dynamic fluid flow in a water-wet porous medium by one or more central processing units (CPUs), comprising generating a set of possible movements of displacement fronts within a set of pore elements within a pore-network representation of a porous media or rough-walled fracture sample, based on the set of possible movements, generating pressure fields for each of the set of possible movements, based on the pressure fields, determining a highest displacement potential for the set of possible movements, and performing a displacement based on the highest displacement potential.

### CROSS-REFERENCE TO RELATED APPLICATIONS

This applications claims benefit of U.S. Provisional Patent Application No. 63/402,001, filed Aug. 29, 2022, the entirety of which is herein incorporated by reference.

### BACKGROUND

### Field

Aspects of the present disclosure generally relate to methods and systems for physical characterization of porous media, and more particularly, to predicting dynamic fluid flow in a water-wet porous medium.

### Description of the Related Art

Modeling techniques for fluid flow through porous media are broadly implemented for petroleum resource development, materials engineering, food packaging, and medical technology development. Fluid flow modeling techniques may be equipped to illustrate both physical and chemical media properties like permeability, capillary pressure, fluid saturation, contact angle, wettability, or other similar properties, which may be used to characterize fluid behavior within a porous media sample without requiring expensive destruction of the sample.

Although current techniques for modeling fluid flow through porous media are based on technological advancements made over many years, resultant models may still be tenuous representations of actual porous media. For example, fluid flow models of porous media may require low-resolution implementations to match currently available computational capabilities. As a result, fluid flow models based on porous media having microscale porosities may not accurately reflect physical and chemical properties of the media. Accordingly, there is an impetus to improve the accuracy of fluid flow modeling, including, for example: improving image processing techniques to allow for higher resolution model input and model output, improving image processing techniques to allow for more accurate model input and model output, improving in-situ characterization extraction techniques to better capture fluid behavior in microscale pore features, enhancing computational processing capability to reduce computational expense, enhancing computational processing capability increase modeling speed, increasing automation for iterative modeling steps, improving model capability for dynamic modeling of different fluid flow environments, improving model capability for dynamic modeling of larger fluid flow environments, and the like.

Consequently, there exists a need for further improvements in fluid flow modeling of porous media and rough-walled fractures to overcome the aforementioned technical challenges and other challenges not mentioned.

### SUMMARY

Aspects provided herein provide a method for predicting dynamic two-phase fluid flow in a water-wet porous medium by one or more central processing units (CPUs). The method may include generating a set of possible movements of displacement fronts within a set of pore elements within a fracture pore network model of a porous media sample. The method may include, based on the set of possible movements, generating pressure fields for each of the set of possible movements. The method may include, based on the pressure fields, identifying a highest displacement potential for the set of possible movements. The method may include.

Aspects provided herein provide a method for predicting dynamic two-phase fluid flow in a water-wet fractured porous medium by one or more central processing units (CPUs). The method may include obtaining a fracture pore network model of a porous media sample. The method may include identifying a set of pore elements within the fracture pore network model. The method may include decomposing the fracture pore network model for processing divided among the one or more CPUs. The method may include applying one or more boundary conditions to the fracture pore network model. The method may include generating a set of possible movements of displacement fronts within the set of pore elements within the fracture pore network model. The method may include based on the set of possible movements, generating pressure fields for each of the set of possible movements by determining, for each of the set of pore elements, a volumetric flow rate of a phase moving through a target pore element and a pore element adjacent to the target pore element. The method may include, based on the pressure fields, generating a highest displacement potential for the set of possible movements using at least a set of capillary pressures. The method may include performing a displacement based on the highest displacement potential. The method may include outputting results of the displacement.

Aspects provided herein provide an apparatus for predicting dynamic two-phase fluid flow in a water-wet porous medium. The apparatus includes a memory and one or more central processing units (CPU). The one or more CPUs may cause the apparatus to perform a method. The method may include generating a set of possible movements of displacement fronts within a set of pore elements within a fracture pore network model of a porous media sample. The method may include, based on the set of possible movements, generating pressure fields for each of the set of possible movements. The method may include, based on the pressure fields, identifying a highest displacement potential for the set of possible movements. The method may include.

Aspects provided herein provide an apparatus for predicting dynamic two-phase fluid flow in a water-wet porous medium. The apparatus includes a memory and one or more central processing units (CPU). The one or more CPUs may cause the apparatus to perform a method. The method may include obtaining a fracture pore network model of a porous media sample. The method may include identifying a set of pore elements within the fracture pore network model. The method may include decomposing the fracture pore network model for processing divided among the one or more CPUs. The method may include applying one or more boundary conditions to the fracture pore network model. The method may include generating a set of possible movements of displacement fronts within the set of pore elements within the fracture pore network model. The method may include based on the set of possible movements, generating pressure fields for each of the set of possible movements by determining, for each of the set of pore elements, a volumetric flow rate of a phase moving through a target pore element and a pore element adjacent to the target pore element. The method may include, based on the pressure fields, generating a highest displacement potential for the set of possible movements using at least a set of capillary pressures. The method may include performing a displacement based on the highest displacement potential. The method may include outputting results of the displacement.

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only example aspects and are therefore not to be considered limiting of its scope, may admit to other equally effective aspects.

### BRIEF DESCRIPTION OF THE DRAWINGS

So that the manner in which the above recited features of the present disclosure can be understood in detail, a more particular description of the disclosure, briefly summarized above, may be had by reference to aspects, some of which are illustrated in the appended drawings. It is to be noted, however, that the appended drawings illustrate only example aspects and are therefore not to be considered limiting of its scope, may admit to other equally effective aspects.

FIG. 1A depicts an example pore network model extracted from a porous media sample made of sandstone.

FIG. 1B depicts an example set of high-resolution porous media image taken by a scanning instrument from a single rock sample and segmented for characterization.

FIG. 2 depicts an example core-flooding instrument for determining the physical and chemical characteristics of a porous media sample.

FIG. 3 depicts an example fluid flow prediction procedure for water-wet rough-walled fractures by one or more central processing units (CPU).

FIG. 4 depicts an example fracture mapped through a porous rock sample taken from Berea sandstone.

FIG. 5 depicts example circum-circle scheme applied by one or more CPUs according to certain aspects of the present disclosure.

FIG. 6 is a flow diagram illustrating certain operations by one or more CPUs, according to certain aspects of the present disclosure.

FIG. 7 is an example device for non-destructive characterization of porous media.

To facilitate understanding, identical reference numerals have been used, where possible, to designate identical elements that are common to the figures. It is contemplated that elements and features of one aspect may be beneficially incorporated in other aspects without further recitation.

### DETAILED DESCRIPTION

In the following, reference is made to aspects of the disclosure. However, it should be understood that the disclosure is not limited to specifically aspects described. Instead, any combination of the following features and elements, whether related to different aspects or not, is contemplated to implement and practice the disclosure. Furthermore, although aspects of the disclosure may achieve advantages over other possible solutions and/or over the prior art, whether or not a particular advantage is achieved by a given aspect is not limiting of the disclosure. Thus, the following aspects, features, embodiments, and advantages are merely illustrative and are not considered elements or limitations of the appended claims except where explicitly recited in a claim(s). Likewise, a reference to “the disclosure” shall not be construed as a generalization of any inventive subject matter disclosed herein and shall not be considered to be an element or limitation of the appended claims except where explicitly recited in a claim(s).

The present disclosure relates to techniques for physical characterization of porous media. Specifically, the techniques discussed herein may be implemented for predicting dynamic two-phase fluid flow in a water-wet porous medium. The porous media sample may comprise a digital rock sample, a rock sample, a core sample, a plastic sample, a tissue sample, a rough-walled fracture space, or any other organic or inorganic sample having pore space ascertainable through imaging techniques.

A thorough grasp of fluid flow through porous spaces of certain materials may be consequential to enhancing technical efficacy of fluid flow techniques in a wide range of industries. Models of fluid flow are useful to describe physical and chemical characteristic of a porous material and may help to highlight the material's optimal usage. Often, networks of pores within a material are extremely small, ranging from microscale to microscale in size. Techniques for characterizing these pore networks are hindered by the computational expense of modeling at a microscale. To alleviate computational burdens, pore network modeling techniques often use generalized characterization techniques at the expense of model accuracy. Extrapolation errors caused by such imprecise characterization may result in mischaracterization of physical and chemical characteristics of the porous material. In many cases, these errors render such models impractical for regular use. Accordingly, ideal modeling of fluid flow through porous media would allow for rapid, accurate characterization of microscale pore spaces that may be performed without inhibitive computational expense.

### INTRODUCTION TO PORE NETWORK MODELING

Modeling techniques for fluid flow through porous media may illustrate both physical and chemical porous media properties. Models of porous media may be used to ascertain permeability, capillary pressure, fluid saturation, wettability, buoyancy, and the like to a greater degree of accuracy comparable to physical flooding of a porous media sample. Additionally, physical and chemical properties determined using pore network modeling techniques may be used to characterize in-situ fluid behavior as it travels through the porous media under a wide variety of wettability and flooding conditions. These conditions may not be accessible to users performing conventional physical flooding characterization techniques.

Permeability is the tendency of the porous media to allow liquids to flow through it. Capillary pressure is the pressure difference existing across the interface separating two immiscible fluids. Fluid saturation is the measurement of fluid present in the pore spaces of the porous media. Contact angle is a measured angle between a fluid-fluid or a fluid-gas interface at a point where it meets a solid surface. Wettability is the ability of a liquid to maintain contact with a solid surface. Wettability may vary depending on wettability conditions and the type of wetting liquid present in the porous media sample. For example, a water-wet medium may show a lower wetting affinity to the oil phase than an oil-wet medium, where higher or lower wetting is determined with respect to a given phase. In certain cases, the correlation between wettability and viscosity ratio may not be straightforward, as there may be water or oil wet conditions with similar viscosities.

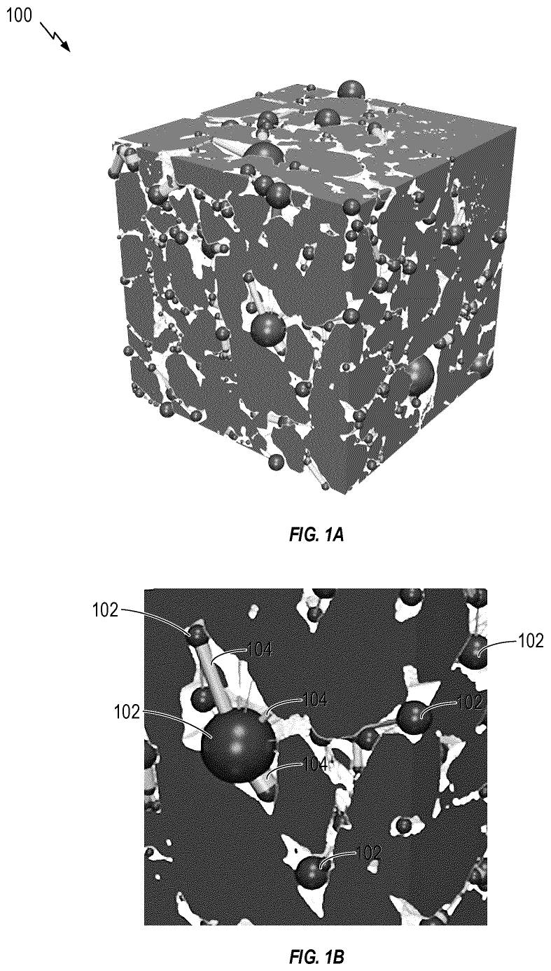

A modeled pore network is a practical description of a porous medium targeted for fluid flow modeling. FIG. 1A illustrates an example section of a pore network extracted from porous sandstone. The section of the pore network describes the porosities of various size and shape present in that portion of the sandstone, and may be used to model fluid flow through those porosities for various wettability conditions. Generally, three-dimensional (3D) portions of a pore network model may more accurately characterize the porous media sample either alone or in combination with other 3D portions of the pore network model. For pore network representing rough-wall fractures, a aperture space of a pore may be defined as a coarse-grained monolayer lattice of grid blocks with varying heights and a maximum coordination number of four. Pores within a fracture pore network have rectangular cross sections, and their heights are determined by the local aperture.

Pore network models (e.g., of FIG. 1A) may be extracted from images of a targeted porous medium or rough-walled fractures and used to model multi-phase fluid flow using physically-based displacement mechanisms (PBDMs) across pores defined in a pore network. PBDMs may represent an estimated displacement of a modeled fluid in response to movement of another fluid or gas within the pore network. As immiscible phases interact with one another throughout the pore network during fluid flooding, PBDMs are induced where, for example, capillary pressure across a meniscus exceeds the wettability constraints on either phase. Fluid saturation, contact angle, buoyancy, and the like may also affect PBDMs throughout a pore network. By utilizing a pore network model extracted from a porous media or rough-walled fracture sample, a user may be able to ascertain PBDMs through the porous media or fracture sample under a wide variety of wettability conditions in order to ultimately obtain, for example, useful permeability for a larger sample of the porous medium without degrading a porous media sample via repeated physical flooding.

To properly generate PBDMs at a pore-scale for the targeted porous media, imaging may capture complex geometries of the targeted porous media or rough-walled fractures at a resolution sufficiently high to retain acceptable accuracy. An example of these geometries is illustrated in FIG. 1B. In some cases, pores may be defined as a complex polyhedron having at least a center 102 and spherical and effective diameters. Connective throats 104 between pores may also be defined. In many cases, image resolution may be in micrometers to capture applicable pore detail. High-resolution pore models allow for accurate rendering of the fluid flow characteristics described above as ascertained at each pore and for each PBDM.

PBDMs may occur upon flooding or draining of a dynamic pore network model, where aqueous phase injection or removal is iteratively constructed through the pore network. Aqueous flooding and aqueous draining may be implemented in various modeled wettability conditions, where certain fluids are present prior to the start of a simulation. Wettability conditions may include at least water-wet conditions. During aqueous flooding, injected water may displace immiscible fluid preexisting in the pore network model. During aqueous draining, injected immiscible fluid may displace water preexisting in the pore network model. In certain cases, flooding and draining may be fluid flooding and fluid draining. In some cases, fluid may be oil.

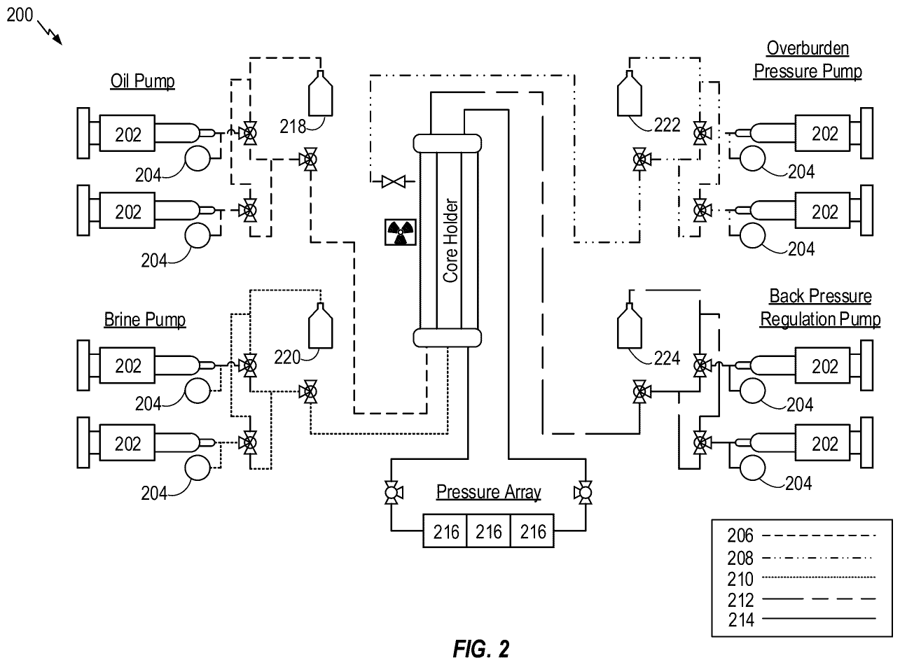

Flooding or draining of a pore network model may be simulated based in part on scanned images of physical flooding implemented by a flooding instrument 200 of FIG. 2. In some cases, a porous media may undergo a core-flooding experiment to establish an irreducible water saturation, a residual oil saturation, or both. Core-flooding may be enabled by a set of pumps 202, rupture disks 204, pump lines 206-214, differential pressure transducers 216, and source buckets 218-222 working in tandem to flood a porous media sample loaded in a core holder. In some cases, a scanning instrument (e.g., a micro computed tomography (micro-CT) scanner) captures a dry reference image prior to flooding. Scanning occurs in a field of view defined within the core holder. In some cases, the porous media sample may be flooded with brine from bucket 220, via the brine tubing line 206, and scanned again to ensure that the porous media sample is fully saturated. Once the brine flooding is complete, the absolute permeability of the porous media sample may be obtained. The oil flooding may be performed alongside additional brine flooding. Any fluid expelled as a result of overburden pressure (i.e., pressure that compacts pore space and reduces permeability) may be transported via the confining fluid line 208 and collected in bucket 222. Any fluid expelled as a result of the flooding procedure may be transported via the effluent fluid line 212 and collected in bucket 224. In many cases, core sample pressure may be iteratively adjusted during flooding. Pressure may be recorded by one or more differential pressure transducers 216 coupled to the core holder via a transducer line 214.

Scanned images obtained from flooding procedures performed by the flooding instrument 200 of FIG. 2 may be used to extract a pore map representative of the porous media sample. The images may be processed to determine characteristics of fluid flow through the porous media sample. In many cases, the images may also be used to extract a representative pore network model.

Imaging of porous media is typically performed using micro-CT imaging. In many cases, commercial micro-CT scanners (e.g., Zeiss scanners) are available for imaging necessary to perform pore-network modeling. Images of porous media taken by micro-CT scanners are at a sufficiently high resolution to create a microscale digital image of the porous media.

In the current state of the art, there exists a challenge of extracting porous media characteristics in a manner precise and repeatable to ensure the ultimate stability of future simulations. Currently, techniques for porous media characterization require lengthy step-wise processing known to incur undue computational expense and introduce instability to characterization of the porous media sample. As a result, users may not be able to rely on characterization output to simulate flow conditions in a useful way.

### ASPECTS RELATED TO DYNAMIC PORE NETWORK MODELING OF TWO-PHASE FLOW IN WATER-WET MEDIA

In the current state of the art, there exists a challenge of predicting fluid flow through porous media in a manner precise and repeatable to ensure the ultimate stability of future simulations. Currently, techniques for two-phase fluid flow prediction require lengthy step-wise processing known to incur undue computational expense and introduce instability to characterization of the porous media sample. As a result, users may not be able to rely on characterization output to simulate flow conditions in a useful way.

Fluid flow modeling through porous media is often utilized to enhance petroleum resource development. In recent years, global demand for energy resources has mobilized development of petroleum reservoirs as targets for hydrocarbon extraction. The geological formations that comprise these hydrocarbon reservoirs are ultra-tight shale formations resistant to primary petroleum extraction techniques. A matrix of an ultra-tight shale reservoir may be characterized by low permeability and low porosity. To extract hydrocarbons from the ultra-tight shale matrix, secondary and tertiary petroleum extraction techniques seek to maximize oil production through the microscale pore networks that comprise a substantial amount of the porosity in the shale matrix.

A robust understanding of fluid flow through microscale pore networks of unconventional reservoirs may be consequential to extracting the trillions of barrels of oil still housed in shale formations globally. Models of fluid flow through a pore network that describe permeability, capillary pressure, fluid saturation, and wettability may help to elucidate specific steps to be taken during resource development to optimize petroleum production. Even so, techniques for characterizing these microscale pore networks are hindered by the computational expense of modeling sub-resolution pore network and extrapolation errors caused by unstable characterization of pore geometries.

As discussed above, ideal modeling of fluid flow through porous media would allow for precise, quick, and repeatable predictive fluid flow modeling procedures through a porous media sample. For example in a case where the porous media sample is a cylindrical core sample of a rock having a length of six inches and a diameter of one inch, the core sample is likely to have porosity and permeability that vary across its length and width. This is common in core samples, and especially in core samples representative of ultra-tight oil formations. Geological processes that form certain oil-bearing rocks can produce heterogeneous (i.e., disordered) morphological features in the rock that may be present even at a sub-resolution scale. This is especially true for oil-bearing carbonate rocks, which contain micro-porosities that contribute significantly to the overall porosity of the rock. These microscale morphological features may affect the pore network of the core sample, which may alter the porosity and permeability throughout a core sample. Thus, accurate characterization of fluid flow through a core sample may depend on precisely ascertained and verifiable microscale geometries sufficient to detect heterogeneous properties of a pore network. These microscale geometries often have complex microscale curvature. Using conventional prediction techniques that cannot consistently capture the heterogeneity of the core sample may result in characterization of a porous media sample that cannot be used to consistently describe fluid flow through the core sample. For instance, current models may assume that either pore bodies or pore throats have volume equivalent to zero. This assumption is unrealistic because the total volume of each of these pore elements may constitute a significant proportion of the pore network present in the porous medium.

Modeling two-phase flow in rock fractures remains a challenge because of the highly irregular geometries of the rough-walled fractures. For example, the aperture spaces of natural rock fractures can spatially vary to a great extent because of the roughness of the fracture surfaces. There is still no consensus regarding how two-phase flow properties behave in a single fracture. To address this problem, aspects of the present disclosure present techniques for dynamic pore-scale modeling platform. Aspects described herein may solve for the forces associated with two-phase displacements in fracture spaces and has an advantage of being computationally efficient. The results generated according to aspects not only improve the understanding of the effects of the aperture geometries on the two-phase flow properties but may enable enhanced fluid flow properties of rough-walled fractures that may be directly adopted for use in predicting flow behaviors in fractured media at the large scale (e.g., meters to kilometers).

Aspects of the present disclosure are directed to techniques for predicting dynamic two-phase fluid flow in a water-wet, fractured porous medium using computationally efficient, parallelized dynamic pore-network models (PNM). Implementation of aspects described herein may facilitate physics-based, pore-scale modeling of two-phase flow processes in representative pore networks that may incorporate a wide range of fluid-fluid properties, including wettability and flow conditions.

According to aspects of the present disclosure, the fluid flow prediction procedure may be performed by a processing system architecture comprising at least one or more CPUs operating in parallel. The one or more CPUs may perform the prediction procedure according to a non-transitory computer readable medium that causes the one or more CPUs to perform any and all steps of the extraction procedure. Each of the one or more CPUs may be utilized in combination with a memory having the computer readable medium stored thereon. Each of the one or more CPUs be utilized in combination with one or more processors. Each of the one or more processors may be parallel processors. Each of the CPUs may operate independently, or may use a message passing interface (MPI) enabling communication between one or more parallel processors for performing the extraction procedure.

Aspects of the present disclosure provide an efficient and robust framework to carry out pore-scale displacements based on the fluid pressure fields that are updated frequently during flow procedures. The efficiency of framework combined with the parallelization of the platform across one or more CPUs may facilitate performing fluid flow prediction in large core-sized pore networks within a practical amount of time.

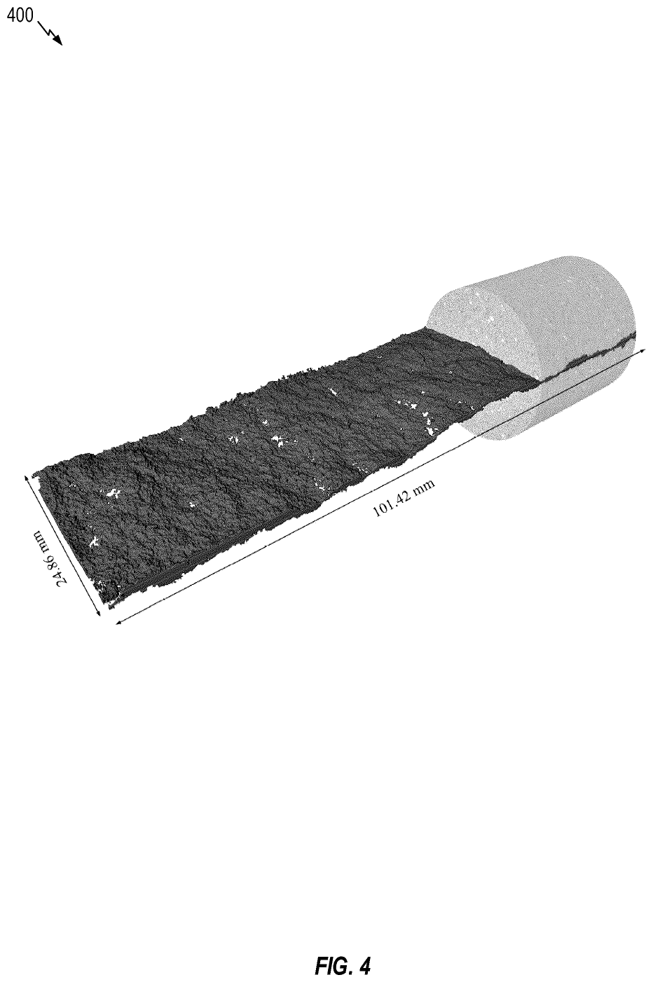

Aspects of the present disclosure provide a heavily-parallelized, dynamic pore-network modeling procedure with efficient computational performance performed by one or more processors. This dynamic pore-network modeling procedure may be utilized to systematically investigate how the geometric features of a rough-walled fracture affect the characteristics of two-phase flow processes (e.g., the pore-network modeling procedure may be useful to describe fluid flow through the fracture of FIG. 4). For instance the four principal geometric features, more specifically spatial correlation length, anisotropy, surface roughness, and the mean aperture size of fractures may impact fluid flow through a fracture. To this end, the one or more processors may first build hundreds of pore networks representing different aperture fields. They include equivalent pore networks of synthetic aperture fields generated using varying geometric parameters.

In a first pre-procedure step, the one or more processors may assess the aperture map of a rock fracture derived from its micro-CT images. The one or more processors may also generate synthetic fractures using four critical geometric parameters that play important roles in controlling multi-phase flow and solute transport in rough-walled fractures. These parameters are aperture spatial correlation length (λ), fracture roughness (σ), aperture anisotropy factor (η), and mean aperture size (b). To create synthetic fractures, the one or more processors first generate a series of aperture fields (e.g., 50×50 mm² aperture fields) with normally-distributed local apertures (b). These aperture fields are created such that their spatial correlation length changes in accordance with a normalized correlation length, where L is the side length of the aperture field, and their anisotropy factor varies. Here, the anisotropy factor reflects the anisotropy of fracture wall surfaces, with η<1 or η>1 indicating that the anisotropy is transverse and parallel to the longitudinal direction of the aperture field, respectively, while η=1 denotes an isotropic aperture field. Next, the processors mathematically transform any aperture field distribution with a specific λ and η into a corresponding aperture field with a targeted mean aperture (b) and a standard deviation (the fracture roughness, σ) through shifting and scaling operations. To achieve statistically representative results, the processors generate aperture field realizations for each set of the geometric parameters. Synthetic aperture fields may have a discretization resolution of 256×256.

After the first pre-procedure step, pore networks that are compatible with the dynamic pore-network modeling procedure are constructed to represent the aperture fields. The one or more processors may assume that the two fracture surfaces are symmetric with respect to a middle plane. The aperture field is then represented as a monolayer lattice of cuboid pores and throats, whose height is determined by the local aperture and width and length are controlled by the di scretization resolution of the aperture field.

According to aspects of the present disclosure, the targeted porous media or fracture sample is water-wet and fluids may be assumed Newtonian, incompressible, and immiscible. Non-wetting blobs surrounded by the wetting fluid may be considered as trapped and immobile. In other words, processors do not consider remobilization of the trapped non-wetting globules that have lost their connectivity to the outlet of the fracture. The processors may allow wetting layers to reside on the rough surfaces of the fracture after the aperture space is invaded by the non-wetting phase. Therefore, the wetting phase does not get trapped since it can always escape the fracture through the connected wetting layers spanning across the network. Hereafter, “pore element” is used as a generic term for both pore and throat spaces. In addition, “water” is used to represent the wetting phase while “oil” is always the non-wetting phase.

The hydraulic conductance of a pore element i in a pore network of a fracture space may be calculated using the local cubic law:

$${g}_{i} = \frac{{b}_{i}^{2} {A}_{u , i}}{12 {μ}_{α}} = \frac{{b}_{i}^{3} δ}{12 {μ}_{α}} , α = o , w$$

where g, b, and A are the hydraulic conductance, aperture, and cross-sectional area of the pore element; α is the phase index with o and w representing oil and water, respectively; μ is the fluid viscosity, and δ is the local lattice spacing (grid resolution size). For a pore element filled with two fluid phases, the effective conductance for each phase is calculated by replacing b with the corresponding phase thickness. In some cases, there may be a correlation between the thickness of water layer b_{w,i} and local capillary pressure p_{c,i}=p_{o,i}−p_{w,i} by fitting the measurements of wetting layer thickness in a single rough fracture as a function of capillary pressure. An assessment of wetting layer thickness is specifically beneficial for performing dynamic pore modelling of rough-walled fractures. This correlation allows the processors to find the thicknesses of the water layer (b_{w,i}) and the oil region (b_{o,i}=bᵢ−_{w,i}) in a pore element from its local capillary pressure. Note that the water layers can swell as the local capillary pressure decreases. This swelling process may continue until the layers contact each other, triggering a snap-off event in small apertures. The processors may implement the snap-off mechanism by allowing a complete displacement of the non-wetting phase from a pore element if its local capillary pressure reaches a critical value, at which the thickness of the water layers equals half the element's aperture. This critical local capillary pressure may defined as the threshold capillary pressure of snap-off displacement inside element i.

At the pore-scale, the direction of fluid-fluid interface movement is governed by the local displacement potential. For instance, in a fluid configuration where there is a main terminal meniscus (MTM), the oil can invade into water in element j if the local drainage potential, Φ^{dra}, is favored. Alternatively, water in element i can imbibe into element j when the local drainage potential, Φ^{imb}, is more favorable. Here, the displacement potential is calculated as:

$$\{ \begin{matrix}{Φ}^{dra} = \text{?} - {p}_{w , j} - \text{?} + {p}_{α} g ( {h}_{i} - {h}_{j} ) sin ϕ \\ {Φ}^{imb} = {p}_{w , j} - {p}_{o , t} + \text{?} + {p}_{w} g ( {h}_{j} - {h}_{i} ) sin ϕ\end{matrix}$$

$$\text{?} \text{indicates text missing or illegible when filed}$$

where p is the pressure of phase α, while [symbol] and [symbol] are the threshold capillary pressures associated with local piston-like drainage and imbibition displacements, respectively; ρ is the phase density, h is the distance from the inlet to the center of the element, and ϕ is the angle between the fracture plane and the horizontal plane. Accordingly, the local flow rate across the MTM, [symbol] is obtained through one of the following three scenarios:

$$\text{?} \{ \begin{matrix}\begin{matrix}\frac{\text{?}}{{L}_{i \_ j}} [ \text{?} - {p}_{w , j} - \text{?} + \\ {p}_{α} g ( {h}_{i} - {h}_{j} ) sin ϕ ] ,\end{matrix} & if {Φ}^{dra} > {Φ}^{imb} and {Φ}^{dra} > 0 \\ \begin{matrix}\frac{\text{?}}{{L}_{i \_ j}} [ {p}_{w , j} - {p}_{o , t} + \text{?} + \\ {p}_{w} g ( {h}_{j} - {h}_{i} ) sin ϕ ] ,\end{matrix} & if {Φ}^{imb} > {Φ}^{dra} and {Φ}^{imb} > 0 \\ 0 , & otherwise\end{matrix} \}$$

$$\text{?} \text{indicates text missing or illegible when filed}$$

The equivalent phase conductance [symbol] through the two neighboring elements is computed using the harmonic mean:

$$\frac{\vert {L}_{i \_ j}}{\text{?}} = \frac{{L}_{i}}{\text{?}} + \frac{{L}_{j}}{\text{?}}$$

$$\text{?} \text{indicates text missing or illegible when filed}$$

and Lᵢ is the half length of the element i.

The threshold capillary pressure for a piston-like displacement in a fracture space is calculated using the following equation:

$$\text{?} = {σ}_{ow} ( {κ}_{1} + {κ}_{2} ) = {σ}_{ow} ( \frac{1}{{R}_{1}} + \frac{1}{{R}_{2}} )$$

$$\text{?} \text{indicates text missing or illegible when filed}$$

where σ_{ow} is the interfacial tension between oil and water, and κ and R are the principal curvatures and the radii of the invading interface. According to aspects, κ₁ and R₁ correspond to the aperture-induced curvature perpendicular to the fracture plane (i.e., out-of-plane curvature and radius), while κ₂ and R₂ relate to the curvature along the fracture plane (i.e., in-plane curvature and radius). In some cases, if one assumes the two fracture surfaces are symmetric around a middle plane, the out-of-plane radius can be geometrically related to the local aperture through the following equation:

$${R}_{1} = \frac{b}{2 c \text{?} ( \text{?} + β )}$$

$$\text{?} \text{indicates text missing or illegible when filed}$$

where θ_{ow} is the local contact angle of the oil-water-solid system, and β is the convergence/divergence angle, the latter of which is considered to be zero in the present work. To account for contact angle hysteresis for pore-level displacements in rough-walled fractures, the one or more processors may assign to each pore element a pair of receding and advancing contact angles for the primary drainage and imbibition displacements, respectively.

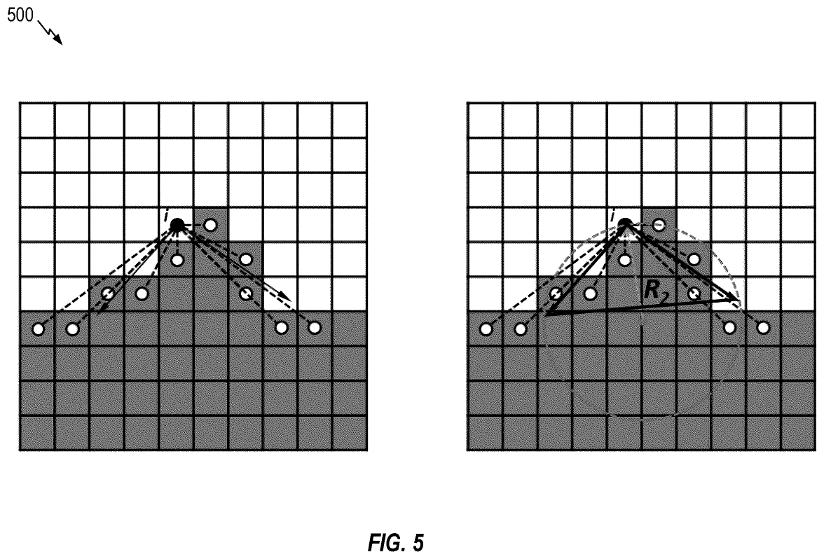

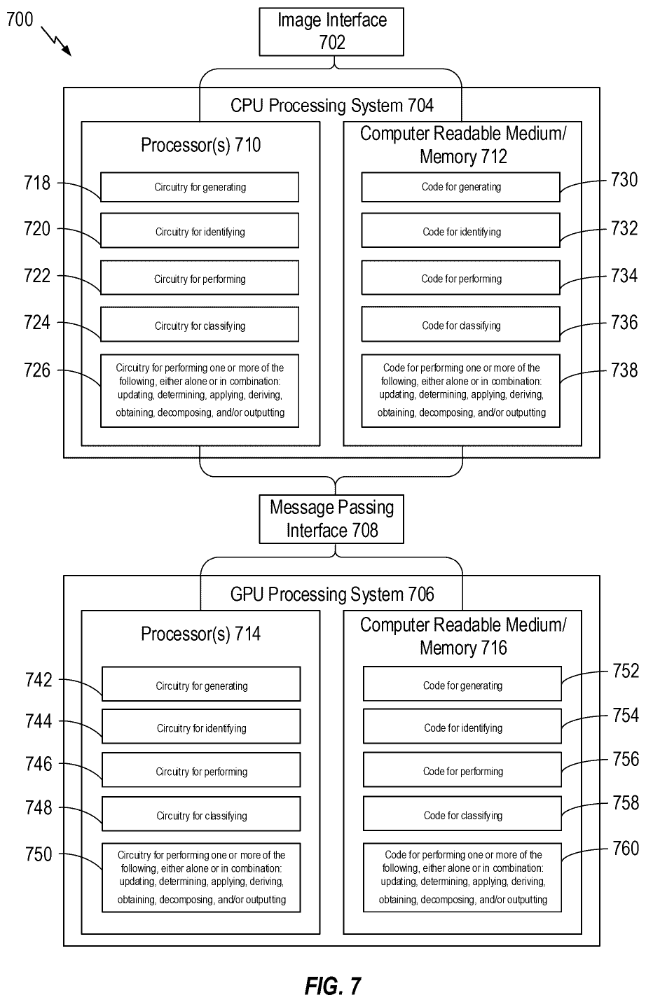

According to certain aspects, the in-plane curvature (κ₂) may characterize the configuration of fluid-fluid interfaces. An assessment of in-plane curvature is specifically beneficial for performing dynamic pore modelling of rough-walled fractures. To simplify the complex process of circle-fitting, the one or more processors utilize a circum-circle as illustrated in FIG. 5. As illustrated in FIG. 7, the one or more processors may first trace a selected number of invaded elements in both clockwise and counterclockwise directions of an invasion site i along the oil-water invasion front. Then, two average vectors may be found from the vectors pointing from i to each of the invaded elements at the left and right sides of the invasion site. Next, a triangle is determined at the invasion front using the coordinates of site i and the endpoints of the two average vectors. Thereafter, a unique circumcircle of the triangle is obtained with a radius of:

$${R}_{2} = \frac{{a}_{t} {b}_{t} {c}_{t}}{4 \text{?}}$$

$$\text{?} \text{indicates text missing or illegible when filed}$$

where aₜ, bₜ, cₜ, and Aₜ are the three side lengths and area of the triangle, respectively. The area Aₜ can be calculated using the following formula:

Aₜ=\sqrt{sₜ(sₜ−aₜ)(sₜ−bₜ)(sₜ−cₜ)}

where sₜ=(aₜ+bₜ+cₜ)/2 is the semi-perimeter of the triangle. The in-plane curvature κ₂ is directly obtained as the reciprocal of the circumcircle's radius. Note that in case of a flat invasion front where the corresponding Aₜ disappears, the resulting in-plane curvature κ₂ is zero. Finally, the positive or negative sign of κ₂ is determined according to the direction of the interface movement at the invasion site and that of the sum of the two average vectors.

To determine the pressure field across a fracture pore network, the volume conservation equation may be applied by one or more processors for each pore element i:

$$\text{?} = 0$$

$$\text{?} \text{indicates text missing or illegible when filed}$$

For single-phase flow, the volumetric flow rate of phase α moving through i and its neighbor element ij (q_{α,i_ij}) is calculated using the following equation:

$$\text{?} = \frac{\text{?}}{{L}_{i \_ ij}} [ ( \text{?} - \text{?} ) + {p}_{α} g ( {h}_{ij} - {h}_{i} ) sin θ ] ,$$

$$α = o , w$$

$$\text{?} \text{indicates text missing or illegible when filed}$$

by listing the volume conservation and volumetric flow rate for every pore and throat, we arrive at the following pressure equations:

$$\text{?} [ ( \text{?} - \text{?} ) + {p}_{α} g ( {h}_{ij} - {h}_{i} ) sin θ ] = 0 ,$$

$$for pore i$$

$$\text{?} [ ( \text{?} - \text{?} ) + {p}_{α} g ( {h}_{i} - {h}_{ij} ) sin θ ] + \text{?} [ ( \text{?} - \text{?} ) + {p}_{α} g ( {h}_{j} - {h}_{ij} ) sin θ ] = 0 ,$$

$$for throat \text{?}$$

$$\text{?} \text{indicates text missing or illegible when filed}$$

where N-throat denotes the coordination number of the pore body.

The one or more processors may determine pressures according to the following equation:

$$\text{?} \frac{\text{?} / \text{?} / \text{?}}{\text{?} / \text{?} / \text{?}} [ ( \text{?} - \text{?} ) + {p}_{α} g ( {h}_{j} - {h}_{i} ) sin θ ] = 0$$

$$for pore i$$

$$\text{?} \text{indicates text missing or illegible when filed}$$

In this way, the total number of pressure equations in the resulting linear system is reduced from the sum of pores and throats to the number of pores only, which significantly lessens the computational cost. After the system of linear pressure equations is solved by the one or more processors, the throat pressures may be back-calculated and use to solve phase pressures in pore bodies.

Compared to a single-phase flowing system, two-phase flow in a rough-walled fracture has far more complex pore-level hydrodynamic interactions. For example, in a pore element containing two fluid phases, the water layers can shrink or swell as the local capillary pressure increases or decreases, respectively. In light of this, an explicit way of modeling two phases flowing through an aperture space is to write the volume-balance equation for each fluid in every pore element. Coupled through a local capillary pressure relationship, the pressures of water and oil phases are then solved together under the constraint that the summation of fluid saturations in an element equals unity. The flow field can be derived from the computed pressure field. The local phase saturations and capillary pressure in each pore element are updated successively using local flow rates and a given global time step. To ensure numerical stability, such dynamic technique requires a strict methodology for time-step size determination such that at most one element can be completely invaded by the end of each time step, resulting in significant computational workload. Aspects of the present disclosure provide a faster dynamic pore network modeling framework designed to model two-phase displacement processes in porous media. The one or more processors assume that for a sufficiently short time period, the fluid configurations in pore elements filled with two phases are in a temporally local steady state. In other words for a known two-phase distribution in the fracture, any changes in the thickness of the wetting layers can be neglected while limited amounts of frontal displacements take place. This assumption is particularly plausible for two-phase flow in aperture space where the volume change of wetting-layers is much smaller than the cumulative volume of displaced fluids under piston-like invasions. According to certain aspects, for any fluid configuration involving two fluid phases, the volume-balance equation may be listed twice: once for the center oil flow and another for the water flow through the layers. Thus, the flow equations are written as follows:

$$\text{?} = 0$$

$$\text{?} = \text{?} = 0$$

$$\text{?} \text{indicates text missing or illegible when filed}$$

For any fluid configurations involving an MTM, for element i, the center flow rate across the MTM may be determined used to account for the movement of the oil-water interface; for element ij, the total flow rate through i and ij is equal to [symbol] . In some cases, the coupled pressure fields of water and oil may be solved together by writing the above equations for all connected elements. In addition, for certain fluid configurations, the phase pressures of throat ij may be replaced by the phase pressures of its neighboring pore bodies to reduce the total number of unknowns in the resulting system of pressure equations as mentioned earlier. In cases where an MTM exists, the pressure equations for the throat may be listed separately.

When performing the dynamic pore-networking modeling procedure, the one or more processors may allow two fluids to be co-injected into a fracture pore network under specified volumetric flow rates following the steady-state relative-permeability measurement techniques. To this end, the processors may apply certain boundary conditions to accommodate co-current flow processes, where the fluids are injected from the inlet of the fracture space and produced from the outlet. Specifically at the inlet of the aperture field, the following two conservation equations are added to the system of pressure equations:

$$\text{?} = - \text{?}$$

$$\text{?} = - \text{?}$$

$$\text{?} \text{indicates text missing or illegible when filed}$$

where N-inlet is the total number of inlet throats, and Q_{α,inlet} is the specified volumetric injection rate of phase α. The local fluid flux Q_{α,inlet} is computed in line with whether an MTM exists or not in the inlet throat. This procedure may also be applicable to unsteady-state displacements, in which case the Q_{α,inlet} of the defending phase is set to zero.

At the outlet of the aperture field, a constant production pressure (p_{w,outlet}) is enforced for the water phase. When the oil phase reaches outlet throats, the oil production pressure (p_{o,outlet}) should be considered to be different from the p_{w,outlet} to avoid discontinuity between the pore-scale capillary pressure at the throats and the outlet capillary pressure. The outlet capillary pressure, p_{c,outlet}=p_{o,outlet}−p_{w,outlet}, should be determined in accordance with the global capillary pressure across the fracture pore network. To this end, for a known phase distribution in the aperture field, the processors may estimate the outlet capillary pressure by averaging pore-scale capillary pressure at the oil-water invasion fronts, as:

$$\{ \begin{matrix}\text{?} = \frac{\text{?} {A}_{i \_ j}}{\text{?} {A}_{i \_ j}} \\ \text{?} = \text{?} - \text{?}\end{matrix}$$

$$\text{?} \text{indicates text missing or illegible when filed}$$

where Ω_{o_w} is the collection of invasion fronts (i.e., MTMs) in the two-phase system, p_{c,i_j} is the local capillary pressure across an MTM forming between an oil element i and its neighboring water element j, and A_{i_j} is the corresponding oil-water interfacial area. Then, the outlet boundary condition for the oil phase is readily obtained from:

[symbol]

Note that as the displacement continues, the outlet capillary pressure may gradually evolve according to the changes in phase distributions.

The resultant system of pressure equations may be solved by the one or more processors with an algebraic multigrid (AMG) preconditioned conjugated gradient (CG) method. One should note that for two-phase flow processes, the presence of capillary pressure jumps at the invasion front prevents a direct solution to the pressure field and an iterative procedure may be required. In view of this, every time that the processors solve for pressure, the previous pressure distribution information is used to evaluate the moving direction of every oil-water interface and to determine the flow accordingly. After the system of pressure equations is solved, the processors assign the solutions to the fluid phases in each pore element and update the directions and formulas of the interfacial fluxes, if necessary. This process is iterated until a converged pressure field across the fracture pore network is achieved. Here, we may consider a pressure solution converged if the residual norm of the vectors of the pressure field solutions between two consecutive iterations satisfies the following tolerance:

$$\text{?} = \frac{‖ {ℙ}^{i + 1} - {ℙ}^{i} ‖}{{ℙ}^{i}} < \text{?}$$

$$\text{?} \text{indicates text missing or illegible when filed}$$

where ϵₚ is the first residual norm of the vector of pressure-field solution, and ϵₜₒₗ is a pre-determined error tolerance. A tolerance of ϵₜₒₗ=10⁻⁴ may be applied.

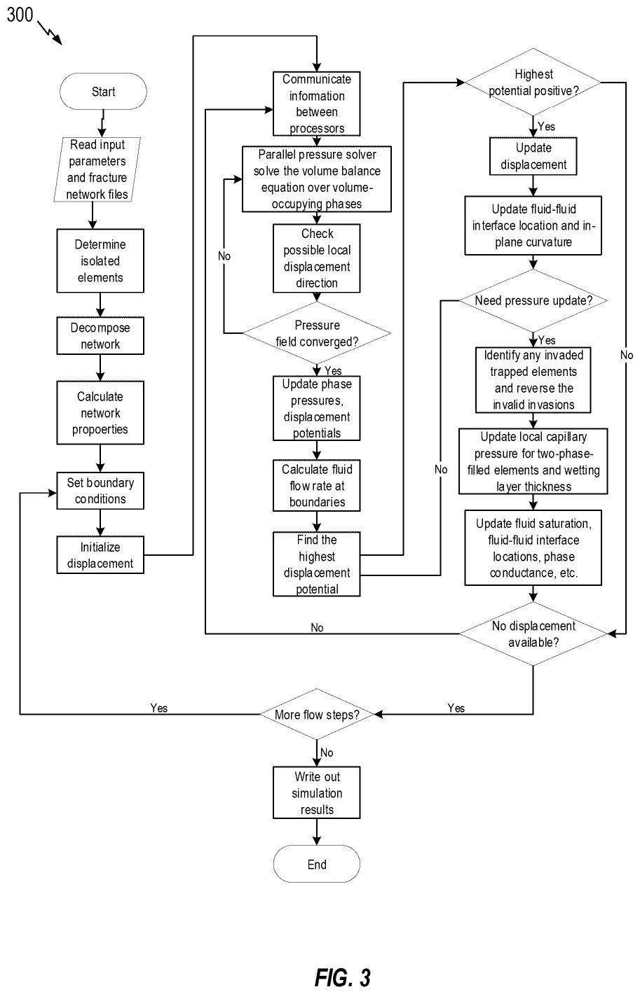

According to certain aspects, the one or more processors may apply a rule-based dynamic procedure with a significantly reduced computational complexity. A general flowchart of the modeling framework is shown in FIG. 3. During two-phase displacement processes, the processors compute the coupled oil and water pressure fields across the network. Subsequently, the processors calculate the potentials for all available displacement events. Each potential is determined based on the pressure difference between the invading and defending phases at the target site, the direction of the interface movement, and the corresponding displacement threshold capillary pressure. For fluid flow in fractures, two fundamental pore-level displacement mechanisms of piston-like and snap-off are included. The potential for piston-like displacement are described above, while the potential for snap-off events in a pore element containing two phases is calculated using the following equation:

[symbol]

where p_{a,i} is the phase pressure and [symbol] is the threshold capillary pressure for snap-off displacement in pore element i. Next, displacements are carried out in the order of highest-to-lowest positive displacement potential. After each displacement, the one or more processors update the locations of the oil-water interfaces, then re-examine the local in-plane curvatures at the invasion fronts, and lastly find new potential invasion sites. This process is continued until either a certain number of displacements (n-disp) are performed or no displacement with positive potential remains. At this stage, flow equations are listed for every connected pore element under the updated phase distribution and then the coupled fluid pressure field is solved again. With newly computed water and oil pressure distributions, local capillary pressures (p_{c,i}=p_{o,i}−p_{w,i}) in pore elements containing two phases are readily updated. Accordingly, the thickness of water layers in these elements is re-evaluated using the p_{c,i} as described above. Overall, during two-phase flow processes, pore-scale displacements are governed by the local displacement potentials.

According to aspects of the present disclosure, the fracture space may initially filled with water during the dynamic pore-network modeling procedure. A series of numerical primary drainage and imbibition tests may be conducted in the fracture under either steady- or unsteady-state two-phase flow conditions. In steady-state primary drainage procedures, oil and water are simultaneously injected into the water-saturated network at a fixed total volumetric flow rate of between about 0.001 cm³/min or more to about 50 cm³/min or less (e.g., 5 cm³/min), though other values are contemplated, while the ratio of oil to water flow rates is increased incrementally. For each fluid injection step, the invasion process is continued until either no displacement with positive potential can occur immediately after the pressure fields are updated or the fraction of oil production reaches its injection fraction. Subsequently, the displacement proceeds to the next flow rate step. This procedure is continued until a targeted oil saturation is achieved. For the subsequent steady-state imbibition process, on the other hand, the fraction of water injection is increased stepwise. As the fraction of the invading phase is gradually increased during the two-phase co-injection process, the ability of the defending phase to flow through the medium is expected to ultimately reduce to zero. During steady-state fluid flow modeling, when the relative permeability of the defending phase drops below 0.01, the injection of the defending phase is ceased. That is, we switch the inlet boundary condition to single-phase injection to sustain a stable numerical scheme. For unsteady-state primary drainage and imbibition procedures, only the invading phase is injected into the fracture pore network under a pre-determined fluid volumetric flow rate.

At a given saturation and fluid distribution, the relative permeability of each phase may be predicted by performing single-phase flow procedure through its sub-network under a fixed volumetric injection rate of Q_{α,inlet}. The computed inlet and outlet pressures p_{α,inlet} and pα,outlet for phase α is then utilized to calculate the relative permeability k_{rα}, as:

$${k}_{r α} = \frac{\text{?} - \text{?}}{\text{?} - \text{?}}$$

$$\text{?} \text{indicates text missing or illegible when filed}$$

Where [symbol] and [symbol] denote the inlet and outlet pressures of phase p when it flows through the entire aperture network under single-phase condition and the same injection rate of Q_{α,inlet}.

At the end of the fluid flow prediction procedure, the one or more processors may output the results of the procedure.

Implementation of certain aspects of the present disclosure may allow accurate representation of complex interplay among capillary, viscous and gravitational forces during two-phase flow processes within a water-wet, fractured porous media sample. The fluid flow procedure may reliably model displacement processes under different flow regimes with varying wettability conditions ranging from, for example, strongly water-wet to neutral-wet states. Its computational efficiency makes it feasible to perform dynamic pore-scale modeling in large-scale pore networks with similar physical dimensions as core samples used in flow experiments. For example users, such as researchers or engineers who may develop or use techniques described herein for developing hydrocarbon reservoirs for petroleum production, may obtain a more robust understanding of fluid flow through porous media on the pore-scale level through proper implementation of techniques described herein microscale. The techniques described herein may reduce porous media sample characterization errors to the benefit of all users seeking a more comprehensive understanding of any given porous media and rough-walled fractures.

### EXAMPLE METHODS

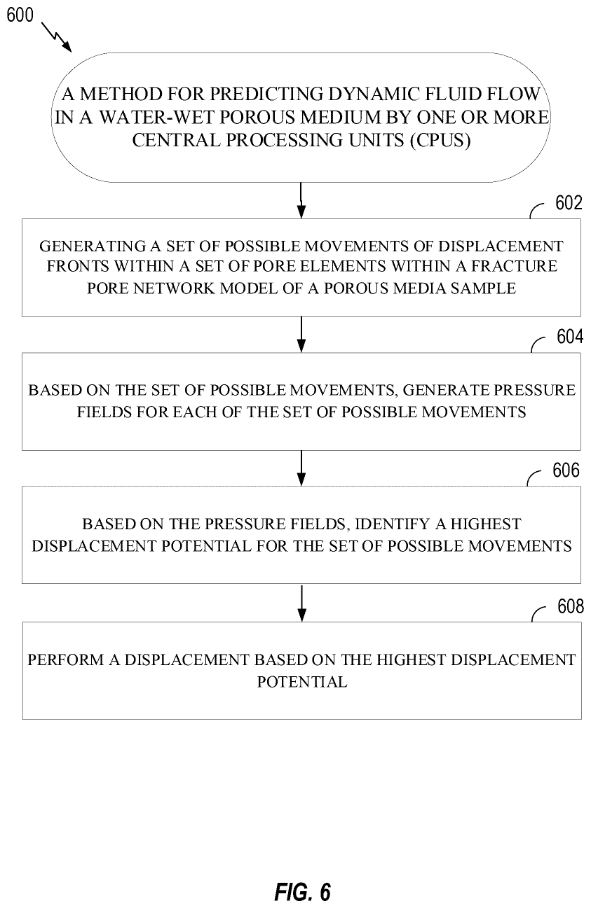

FIG. 6 depicts a method 600 for pore network extraction by one or more CPUs, such as the CPUs of the device 700 of FIG. 7.

Method 600 begins at 602 with one or more CPUs generating a set of possible movements of displacement fronts within a set of pore elements within a fracture pore network model of a porous media sample.

Method 600 continues to step 604 with one or more CPUs, based on the set of possible movements, generating pressure fields for each of the set of possible movements.

Method 600 continues to step 606 with one or more CPUs, based on the pressure fields, identifying a highest displacement potential for the set of possible movements.

Method 600 continues to step 608 with one or more CPUs performing a displacement based on the highest displacement potential.

In one aspect, method 600, or any aspect related to it, may be performed by an apparatus, such as device 700 of FIG. 7, which includes various components operable, configured, or adapted to perform the method 600.

Note that FIG. 6 is just one example of a method, and other methods including fewer, additional, or alternative steps are possible consistent with this disclosure.

### EXAMPLE DEVICE

FIG. 7 depicts aspects of an example porous media characterization device 700. In some aspect, the device 700 comprises one or more CPUs, one or more GPUs, or both as described above with respect to FIG. 6.

The device 700 includes a CPU processing system 704 coupled to an image interface 702 (e.g., a user interface or and/or an image generator such as a commercial micro-CT scanner). The CPU processing system 704 may be configured to perform processing functions for the device 700, including pore network extraction performed by the device 700.

The CPU processing system 704 includes one or more processors 710. The one or more processors 710 are coupled to a computer-readable medium/memory 712 via a bus. The one or more processors 710 and the computer-readable medium/memory 712 may communicate with the one or more processor 714 and the computer-readable medium/memory 716 of the GPU processing system 706 via a message passing interface (MPI) 708. In certain aspects, the computer-readable medium/memory 712 is configured to store instructions (e.g., computer-executable code) that when executed by the one or more processors 710, cause the one or more processors 710 to perform the method 600 described with respect to FIG. 6, or any aspect related to it. Note that reference to a processor performing a function of device 700 may include one or more processors performing that function of device 700.

In the depicted example, computer-readable medium/memory 712 stores code (e.g., executable instructions) 730-738 for performing techniques described herein, according to aspects of the present disclosure. Processing of the code 730-738 may cause the device 700 to perform the method 600 described with respect to FIG. 6, or any aspect related to it.

The one or more processors 710 include circuitry configured to implement (e.g., execute) the code stored in the computer-readable medium/memory 712, including circuitry 718-726 for performing techniques described herein, according to aspects of the present disclosure. Processing with circuitry 718-726 may cause the device 700 to perform the method 600 described with respect to FIG. 6, or any aspect related to it.

Various components of the device 700 may provide means for performing the method 600 described with respect to FIG. 6, or any aspect related to it.

The device 700 includes a GPU processing system 706. The GPU processing system 706 may be configured to perform processing functions for the device 700, pore network extraction performed by the device 700.

The GPU processing system 706 includes one or more processors 714. The one or more processors 714 are coupled to a computer-readable medium/memory 716 via a bus. The one or more processors 714 and the computer-readable medium/memory 716 may communicate with the one or more processor 710 and the computer-readable medium/memory 712 of the CPU processing system 704 via an MPI 708. In certain aspects, the computer-readable medium/memory 716 is configured to store instructions (e.g., computer-executable code) that when executed by the one or more processors 714, cause the one or more processors 714 to perform the method 600 described with respect to FIG. 6, or any aspect related to it. Note that reference to a processor performing a function of device 700 may include one or more processors performing that function of device 700.

In the depicted example, computer-readable medium/memory 716 stores code (e.g., executable instructions) for performing certain functions according to aspects of the present disclosure 752-760. Processing of the code 752-760 may cause the device 700 to perform the method 600 described with respect to FIG. 6, or any aspect related to it.

The one or more processors 714 include circuitry configured to implement (e.g., execute) the code stored in the computer-readable medium/memory 716, including circuitry for performing certain functions according to aspects of the present disclosure 742-750. Processing with circuitry 742-750 may cause the device 700 to perform the method 600 described with respect to FIG. 6, or any aspect related to it.

Various components of the device 700 may provide means for performing the method 600 described with respect to FIG. 6, or any aspect related to it.

### EXAMPLE ASPECTS

Implementation examples are described in the following numbered aspects:
Aspect 1: A method for predicting dynamic two-phase fluid flow in a water-wet porous medium by one or more central processing units (CPUs), comprising: generating a set of possible movements of displacement fronts within a set of pore elements within a fracture pore network model of a porous media sample; based on the set of possible movements, generating pressure fields for each of the set of possible movements; based on the pressure fields, identifying a highest displacement potential for the set of possible movements; and performing a displacement based on the highest displacement potential.
Aspect 2: The method of aspect 1, wherein identifying the highest displacement potential comprises identifying a local displacement based on at least a set of viscous pressures, capillary pressures, and gravitational pressures.
Aspect 3: The method of any one of aspects 1 and 2, wherein generating the pressure fields comprises: for each of the set of pore elements, generating a volumetric flow rate of a phase moving through a target pore element and a pore element adjacent to the target pore element.
Aspect 4: The method of any one of aspects 1 through 3, further comprising: classifying the pressure fields for each of the displacement fronts as having converged or as having not converged.
Aspect 5: The method any one of aspects 1 through 4, further comprising: based the pressure fields, updating a set of phase pressures and a set of displacement potentials; and based on at least the set of phase pressure and the set of displacement potentials, generating a set of fluid flow rates at boundaries of the fracture pore network model; and estimating an outlet capillary pressure at an outlet boundary of the fracture pore network model based, at least in part, on the set of fluid flow rates.
Aspect 6: The method of any one of aspects 1 through 5, wherein determining the highest displacement potential comprises: classifying the highest displacement potential as a positive value or a negative value; and if the highest displacement potential is a negative value, determining whether a displacement with a positive value is available.
Aspect 7: The method of any one of aspects 1 through 6, further comprising: based on the displacement, updating a set of fluid-fluid interface (FFI) locations and a set of in-plane curvatures.
Aspect 8: The method of aspect 7, wherein updating the set of in-plane curvatures comprises: applying a circum-circle to a set of invaded pore elements; and deriving the set of in- plane curvatures based on a reciprocal of a radius of the circum-circle.
Aspect 9: The method of any one of aspects 7 and 8, further comprising: updating the pressure fields based on updating the set of FFIs and the set of in-plane curvatures.
Aspect 10: The method of aspect 9, further comprising: identifying invaded elements or trapped elements within the fracture pore network model.
Aspect 11: The method of any one of aspects 9 and 10, further comprising: updating at least one of a set of local capillary pressures for two-phase-filled elements within the fracture pore network model, a wetting layer thickness, a fluid saturation value, the set of FFI locations, and a set of phase conductance values.
Aspect 12: The method of aspect 11, wherein the set of phase conductance values are updated based on at least a hydraulic conductance value of one of the set of pore elements, an aperture of one of the set of pore elements, a wetting layer thickness of one of the set of pore elements, a cross-sectional value of one of the set of pore elements, a phase index of a wetting phase, a phase index of a non-wetting phase, a fluid viscosity, and a local lattice spacing determined based on the fracture pore network model.
Aspect 13: The method of any one of aspects 1 through 12, further comprising: obtaining the fracture pore network model; identifying the set of pore elements within the fracture pore network model; decomposing the fracture pore network model for processing divided among the one or more CPUs; and applying one or more boundary conditions to the fracture pore network model.
Aspect 14: The method of aspect 13, wherein the one or more boundary conditions comprise an inlet flow rate and an outlet production pressure.
Aspect 15: The method of any one of aspects 1 through 14, wherein the pore elements comprise a set of pore spaces and a set of throat spaces.
Aspect 16: The method of any one of aspects 1 through 15, further comprising outputting results of the displacement.
Aspect 17: The method of any one of aspects 1 through 16, wherein the one or more CPUs communicate via a message passing interface (MPI).
Aspect 18: The method of any one of aspects 1 through 17, wherein the displacement fronts comprise at least a wetting phase and a non-wetting phase.
Aspect 19: The method of aspect 18, wherein the wetting phase resides on a rough surface of the fracture pore network model after an invasion of the non-wetting phase.
Aspect 20: The method of any one of aspects 18 and 19, wherein the wetting phase is a water and the non-wetting phase is an oil.
Aspect 21: The method of any one of aspects 18 through 20, wherein the displacement comprises a snap-off displacement or a piston-like displacement.
Aspect 22: The method of any one of aspects 1 through 21, wherein the porous media sample comprises a digital rock sample.
Aspect 23: A method for predicting dynamic two-phase fluid flow in a water-wet fractured porous medium by one or more central processing units (CPUs), comprising: obtaining a fracture pore network model of a porous media sample; identifying a set of pore elements within the fracture pore network model; decomposing the fracture pore network model for processing divided among the one or more CPUs; and applying one or more boundary conditions to the fracture pore network model; generating a set of possible movements of displacement fronts within the set of pore elements within the fracture pore network model; based on the set of possible movements, generating pressure fields for each of the set of possible movements by determining, for each of the set of pore elements, a volumetric flow rate of a phase moving through a target pore element and a pore element adjacent to the target pore element; based on the pressure fields, generating a highest displacement potential for the set of possible movements using at least a set of capillary pressures; performing a displacement based on the highest displacement potential; and outputting results of the displacement.
Aspect 24: An apparatus, comprising: a memory comprising executable instructions; and a processor configured to execute the executable instructions and cause the apparatus to perform a method in accordance with any one of Aspects 1-23.
Aspect 25: An apparatus, comprising means for performing a method in accordance with any one of Aspects 1-23.

Aspect 26: A non-transitory computer-readable medium comprising executable instructions that, when executed by a processor of an apparatus, cause the apparatus to perform a method in accordance with any one of Aspects 1-23.

Aspect 27: A computer program product embodied on a computer-readable storage medium comprising code for performing a method in accordance with any one of Aspects 1-23.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). The singular forms “a,” “an,” and “the” include plural referents, unless the context clearly dictates otherwise. Within a claim, reference to an element in the singular is not intended to mean “one and only one” unless specifically so stated, but rather “one or more.” Unless specifically stated otherwise, the term “some” refers to one or more.

As used herein, the term “determining” encompasses a wide variety of actions. For example, “determining” may include calculating, computing, processing, deriving, investigating, updating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, simulating, choosing, establishing, and the like.

The methods disclosed herein comprise one or more operations or actions for achieving the methods. The method operations and/or actions may be interchanged with one another without departing from the scope of the claims. In other words, unless a specific order of operations or actions is specified, the order and/or use of specific operations and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in the figures, those operations may have corresponding counterpart means-plus-function components with similar numbering.

When the word “approximately” or “about” are used, this term may mean that there may be a variance in value of up to ±10%, of up to 5%, of up to 2%, of up to 1%, of up to 0.5%, of up to 0.1%, or up to 0.01%.

Ranges may be expressed as from about one particular value to about another particular value, inclusive. When such a range is expressed, it is to be understood that another embodiment is from the one particular value to the other particular value, along with all particular values and combinations thereof within the range.

As used, terms such as “first” and “second” are arbitrarily assigned and are merely intended to differentiate between two or more components of a system, an apparatus, or a composition. It is to be understood that the words “first” and “second” serve no other purpose and are not part of the name or description of the component, nor do they necessarily define a relative location or position of the component. Furthermore, it is to be understood that that the mere use of the term “first” and “second” does not require that there be any “third” component, although that possibility is envisioned under the scope of the various embodiments described.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

Unless defined otherwise, all technical and scientific terms used have the same meaning as commonly understood by one of ordinary skill in the art to which these systems, apparatuses, methods, processes and compositions belong.

The following claims are not intended to be limited to the embodiments provided but rather are to be accorded the full scope consistent with the language of the claims.

What is claimed is:

1. A method for predicting dynamic two-phase fluid flow in a water-wet porous medium by one or more central processing units (CPUs), comprising:
generating a set of possible movements of displacement fronts within a set of pore elements within a fracture pore network model of a porous media sample;
based on the set of possible movements, generating pressure fields for each of the set of possible movements;
based on the pressure fields, identifying a highest displacement potential for the set of possible movements; and
performing a displacement based on the highest displacement potential.

2. The method of claim 1, wherein identifying the highest displacement potential comprises identifying a local displacement based on at least a set of viscous pressures, capillary pressures, and gravitational pressures.

3. The method of claim 1, wherein generating the pressure fields comprises:
for each of the set of pore elements, generating a volumetric flow rate of a phase moving through a target pore element and a pore element adjacent to the target pore element.

4. The method of claim 1, further comprising:
classifying the pressure fields for each of the displacement fronts as having converged or as having not converged.

5. The method of claim 1, further comprising:
based the pressure fields, updating a set of phase pressures and a set of displacement potentials; and
based on at least the set of phase pressure and the set of displacement potentials, generating a set of fluid flow rates at boundaries of the fracture pore network model; and
estimating an outlet capillary pressure at an outlet boundary of the fracture pore network model based, at least in part, on the set of fluid flow rates.

6. The method of claim 1, wherein determining the highest displacement potential comprises:
classifying the highest displacement potential as a positive value or a negative value; and
if the highest displacement potential is a negative value, determining whether a displacement with a positive value is available.

7. The method of claim 1, further comprising:
based on the displacement, updating a set of fluid-fluid interface (FFI) locations and a set of in-plane curvatures.

8. The method of claim 7, wherein updating the set of in-plane curvatures comprises:
applying a circum-circle to a set of invaded pore elements; and
deriving the set of in-plane curvatures based on a reciprocal of a radius of the circum-circle.

9. The method of claim 7, further comprising:
updating the pressure fields based on updating the set of FFIs and the set of in-plane curvatures.

10. The method of claim 9, further comprising:
identifying invaded elements or trapped elements within the fracture pore network model.

11. The method of claim 9, further comprising updating at least one of a set of local capillary pressures for two-phase-filled elements within the fracture pore network model, a wetting layer thickness, a fluid saturation value, the set of FFI locations, and a set of phase conductance values.

12. The method of claim 1, further comprising:
obtaining the fracture pore network model;
identifying the set of pore elements within the fracture pore network model;
decomposing the fracture pore network model for processing divided among the one or more CPUs; and
applying one or more boundary conditions to the fracture pore network model, wherein the one or more boundary conditions comprise an inlet flow rate and an outlet production pressure.

13. The method of claim 1, wherein the pore elements comprise a set of pore spaces and a set of throat spaces.

14. The method of claim 1, wherein the displacement fronts comprise at least a wetting phase and a non-wetting phase, wherein the wetting phase resides on a rough surface of the fracture pore network model after an invasion of the non-wetting phase.

15. The method of claim 14, wherein the wetting phase is a water and the non-wetting phase is an oil.

16. The method of claim 14, wherein the displacement comprises a snap-off displacement or a piston-like displacement.

17. The method of claim 1, wherein the porous media sample comprises a digital rock sample.

18. A method for predicting dynamic two-phase fluid flow in a water-wet fractured porous medium by one or more central processing units (CPUs), comprising:
obtaining a fracture pore network model of a porous media sample;
identifying a set of pore elements within the fracture pore network model;
decomposing the fracture pore network model for processing divided among the one or more CPUs; and
applying one or more boundary conditions to the fracture pore network model;
generating a set of possible movements of displacement fronts within the set of pore elements within the fracture pore network model;
based on the set of possible movements, generating pressure fields for each of the set of possible movements by determining, for each of the set of pore elements, a volumetric flow rate of a phase moving through a target pore element and a pore element adjacent to the target pore element;
based on the pressure fields, generating a highest displacement potential for the set of possible movements using at least a set of capillary pressures;
performing a displacement based on the highest displacement potential; and
outputting results of the displacement.

19. An apparatus for predicting dynamic two-phase fluid flow in a water-wet porous medium comprising a memory and one or more central processing units (CPU), the one or more CPUs configured to cause the apparatus to:
generate a set of possible movements of displacement fronts within a set of pore elements within a fracture pore network model of a porous media sample;
based on the set of possible movements, generate pressure fields for each of the set of possible movements;
based on the pressure fields, identify a highest displacement potential for the set of possible movements; and
perform displacement based on the highest displacement potential.

20. An apparatus for predicting dynamic two-phase fluid flow in a water-wet porous medium comprising a memory and one or more central processing units (CPU), the one or more CPUs configured to cause the apparatus to:
obtain a fracture pore network model of a porous media sample;
identify a set of pore elements within the fracture pore network model;
decompose the fracture pore network model for processing divided among the one or more CPUs; and
apply one or more boundary conditions to the fracture pore network model;
generate a set of possible movements of displacement fronts within the set of pore elements within the fracture pore network model;
based on the set of possible movements, generate pressure fields for each of the set of possible movements by determining, for each of the set of pore elements, a volumetric flow rate of a phase moving through a target pore element and a pore element adjacent to the target pore element;
based on the pressure fields, generate a highest displacement potential for the set of possible movements using at least a set of capillary pressures;
perform a displacement based on the highest displacement potential; and
output results of the displacement.
